(19) United States
(12) Patent Application Publication
(10) Pub. No.: US 2014/0137100 A1
(43) Pub. Date: May 15, 2014

(54) METHOD AND SYSTEM FOR INSTALLING SHORTCUT THROUGH MOBILE APPLICATION

(71) Applicant: NHN CORPORATION, Seongnam-si (KR)

(72) Inventors: Man Ho WON, Seongnam-si (KR); Jong Kwon Lee, Seongnam-si (KR); Dongkil Shin, Seongnam-si (KR); Heeyoon Yeom, Seongnam-si (KR); SungBok LEE, Seongnam-si (KR); Minjin Lee, Seongnam-si (KR)

(73) Assignee: NHN Corporation, Seongnam-si (KR)

(21) Appl. No.: 13/856,144

(22) Filed: Apr. 3, 2013

(30) Foreign Application Priority Data
Nov. 13, 2012 (KR) 10-2012-0128073

(51) Int. Cl. G06F 9/445

(52) U.S. Cl. CPC G06F 8/61
USPC 717/176

(57) ABSTRACT

Provided is a method and system for installing a shortcut on a desktop, for example, through a mobile application. The method of installing the shortcut on the desktop may include importing a connecting application and activating an installation function on a browser providing a web service, importing a uniform resource locator (URL) scheme specified by the connecting application, and installing a shortcut to the web service on the desktop.

### CROSS-REFERENCE TO RELATED APPLICATION

This application claims priority from and the benefit of Korean Patent Application No. 10-2012-0128073, filed on Nov. 13, 2012, which is hereby incorporated by reference for all purposes as if fully set forth herein.

### BACKGROUND OF THE INVENTION

1. Field

Exemplary embodiments of the present invention relate to a method and system for installing a shortcut on a desktop through a mobile application.

2. Discussion of the Background

Conventionally, a user connects to a digital content program, for example, the APP STORE or GOOGLE PLAY, and retrieves and installs a desired application. The installation installs a shortcut and a shortcut icon, to the installed service or application on a device, such as, a mobile device, a desktop, an Internet enabled television, and the like. The device can include a mobile device, for example, a smartphone, a tablet personal computer (PC), and the like.

Searching for such digital content programs is inconvenient, because a great number of applications are listed when a user attempts to retrieve a suitable application for a device, and the user may need to examine the applications individually to find a desired application.

Korean Patent Application Publication No. 2012-0035480 discloses a mobile communication terminal and an application installation method thereof, particularly a mobile communication terminal for installing and running an external application on an external platform connected to an internal platform through an interface, and an application installation method thereof.

Recently, various approaches are being suggested for easy and convenient retrieval and installation of applications.

### SUMMARY OF THE INVENTION

Exemplary embodiments of the present invention provide a method for conveniently installing a shortcut on a desktop or a home screen, in order for a user to use a frequently used web service and a system for performing the method.

Exemplary embodiments of the present invention also provide a method and a system for installing shortcuts to various web services provided through a connecting application on a mobile device, thus providing a user with convenient use of the web services.

Additional features of the invention will be set forth in the description that follows, and in part will be apparent from the description, or may be learned by practice of the invention.

An exemplary embodiment of the present invention discloses a computer-implemented method of installing a shortcut on a desktop, the method including: importing, by the computer, a connecting application and activating an installation function on a browser providing a web service, importing a uniform resource locator (URL) scheme specified by the connecting application, and installing a shortcut to the web service on the desktop.

An exemplary embodiment of the present invention discloses a computer-implemented method of installing a shortcut on a desktop, the method including: identifying, by the computer, activation of a link for installing a shortcut associated with a connecting application providing a web service, importing a uniform resource locator (URL) scheme specified by the connecting application, and installing a shortcut for activating the web service on the desktop.

An exemplary embodiment of the present invention discloses a system for installing a shortcut on a desktop of a mobile device, the system including: an application import unit configured to import a connecting application and activate an installation function on a browser providing a web service, a uniform resource locator (URL) import unit configured to import a URL scheme specified by the connecting application, and an installation unit configured to install a shortcut to the web service on the desktop.

An exemplary embodiment of the present invention discloses a system for installing a shortcut on a desktop of a mobile device, the system including: an identification unit configured to identify activation of a link for installing a shortcut on a connecting application providing a web service, an import unit configured to import a uniform resource locator (URL) scheme specified by the connecting application, an installation unit configured to install a shortcut to the web service on the desktop, and a processor to execute one or more of the application import unit, the URL import unit, and the installation unit.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 illustrates a browser and a web service providing a shortcut installation link according to exemplary embodiments of the present invention.

FIG. 2 illustrates installation of a shortcut on a browser according to exemplary embodiments of the present invention.

FIG. 3 illustrates activation of a shortcut installed on a desktop according to exemplary embodiments of the present invention.

FIG. 4 illustrates a shortcut previously installed according to exemplary embodiments of the present invention.

FIG. 5 illustrates creation of a shortcut in a connecting application environment according to exemplary embodiments of the present invention.

FIG. 6 illustrates a connecting application that is yet to be installed or requires updating according to exemplary embodiments of the present invention.

FIG. 7 illustrates a method of installing a shortcut on a desktop according to exemplary embodiments of the present invention.

FIG. 8 illustrates a method of installing a shortcut on a desktop according to exemplary embodiments of the present invention.

FIG. 9 illustrates a system for installing a shortcut on a desktop according to exemplary embodiments of the present invention.

FIG. 10 illustrates a system for installing a shortcut on a desktop according to exemplary embodiments of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

In addition, embodiments described in the specification are wholly hardware, and may be partially software or wholly software. In the specification, “unit”, “module”, “device”, “system”, or the like represents a computer related entity such as hardware, combination of hardware and software, or software. For example, in the specification, the unit, the module, the device, the system, or the like may be an executed process, a processor, an object, an executable file, a thread of execution, a program, and/or a computer, but are not limited thereto. For example, both of an application which is being executed in the computer and a computer may correspond to the unit, the module, the device, the system, or the like in the specification.

It will be understood that when an element is referred to as being “connected to” another element, it can be directly connected to the other element, or intervening elements may be present.

Hereinafter, a method and system for installing a shortcut on a desktop will be described in detail with reference to the accompanying drawings.

Exemplary embodiments of the present invention are to provide a web service run in various mobile devices as a shortcut application on a desktop, for example, a mobile device deploying an ANDROID operating system. These exemplary embodiments of the present invention provide a method and a system for installing a shortcut, which may be easily applied to various environments, without limiting to particular devices and launchers.

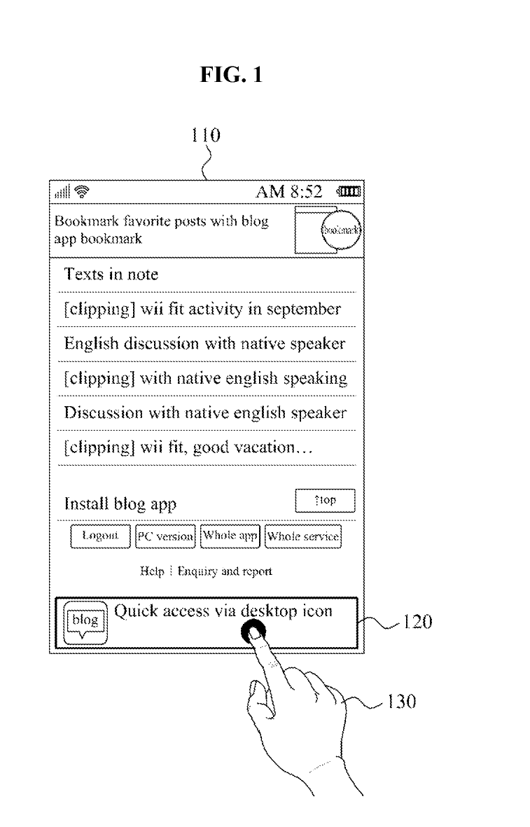

FIG. 1 illustrates a browser and a web service providing a shortcut installation link according to exemplary embodiments of the present invention. In a mobile device, such as, a smartphone and a tablet PC, a browser 110 can provide a screen on which an application, for example, a browser program, is activated to install a shortcut to a web service being displayed on the browser 110.

As shown in FIG. 1, a link or an icon 120 (hereinafter, collectively referred to as a “link”) recommending installation of the shortcut to the web service is displayed for example, at a bottom of the browser 110. The link 120 may be provided not only on a main page of each web service but also on a subpage of the web service.

A mobile device utilizing an exemplary embodiment of the present invention may include a touch screen, such as a capacitive or pressure sensitive touch screen. The link 120 of the browser may be selected using any suitable device, such as a user finger 130, as seen in FIG. 1. Suitable devices can also include, for example, a touch pen. how does a user finger include a touch pen? I revised to clear that up.

The browser 110 may provide various types of web services, such as, an e-mail service, a café, a dictionary, a blogging service, a shopping mall, a map, a real estate service, an online storage service, and the like. In some embodiments, the shortcut installation link 120 may not be provided with respect to communal screens of a web service, for example, a page displaying an all web services provided, a search result page, a login page, and a personal information page, as well as pages for terms and conditions for use, help, inquiries, and feedback.

The web service displayed on the browser 110 may include web services to be provided through a connecting application, and the connecting application may include a browser function to provide a web service.

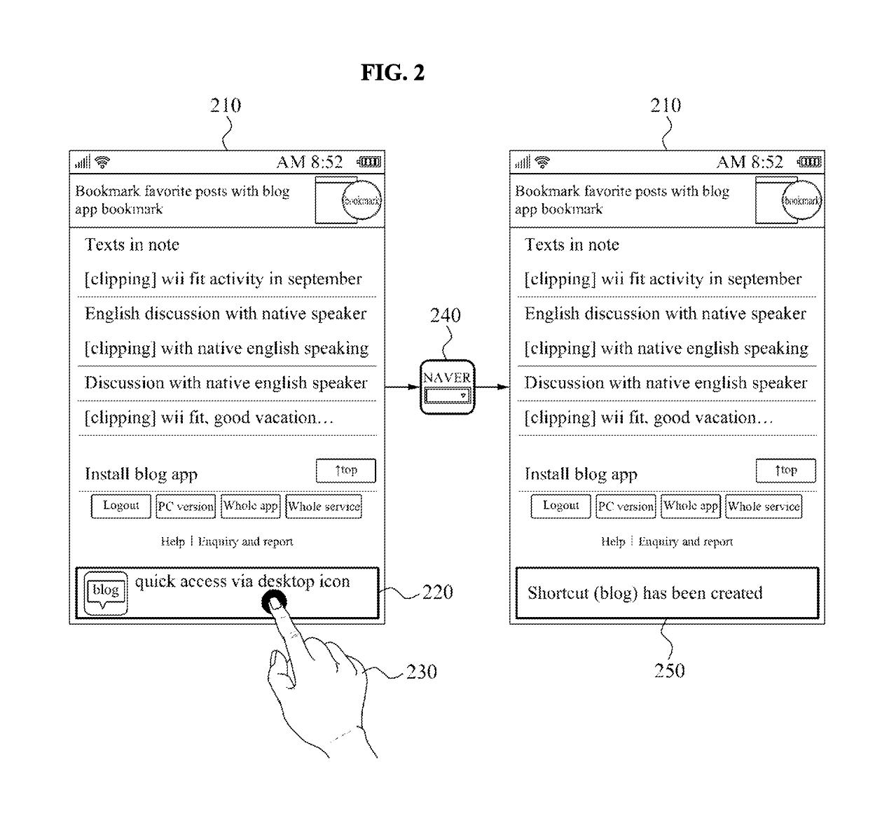

FIG. 2 illustrates installation of a shortcut within a browser according to exemplary embodiments of the present invention. Here, a browser 210 corresponds to the browser 110 shown in FIG. 1. Browser 210 displays a subpage of a blog web service, and on the subpage, a link 220 for installing a shortcut on a desktop is displayed on a bottom of the web page. A user may select the link 220 via a finger 230 or a stylus.

When the link 220 is selected and activated, the browser 210 providing the web service may import a connecting application 240 and install a shortcut on the desktop through the connecting application 240. In detail, the connecting application 240 may be activated directly in the browser 210 environment. The connecting application 240, selected via the link 220, installs a shortcut icon to the web service on the desktop.

In some embodiments, the connecting application 240 specifies and stores a uniform resource locator (URL) scheme for the web service. In installing a shortcut, the URL scheme for the web service specified by the connecting application 240 is imported and the shortcut to the web service displayed on the browser 210 may be disposed on the desktop based on the URL scheme, instead of by an application installation program.

An operation of the URL scheme mentioned above is described in detail as follows. A URL can comprise a character string “http://, “ftp://,” or “market://” (usually a prefix) also known as a URL scheme. In one exemplary embodiment, when the link 220 is activated on a page providing a web service, a corresponding URL scheme is transmitted to a system of a mobile device. The system may identify the URL scheme and search for an executable application in accordance or associated with the URL scheme. When an application servicing or accommodating the URL is located, the application is activated and the URL scheme is transmitted to the application, thereby installing a shortcut to the web service corresponding to the URL scheme. Here, the application accommodating or servicing the URL is the connecting application 240.

When the shortcut is created through the connecting application 240, a popup 250 indicating that the shortcut has been completely created may be displayed, for example, in the form of a notification, on the browser 210. In the present exemplary embodiment, the popup 250 is a toast type popup, which may be provided by the mobile device and be presented in different modes based on types of the devices or installation of a launcher. Thus, in the present exemplary embodiment, activation of the connecting application 240 in the creation of the shortcut may not be displayed on the device but rather be reported only via the popup 250 indicating that the shortcut has been installed.

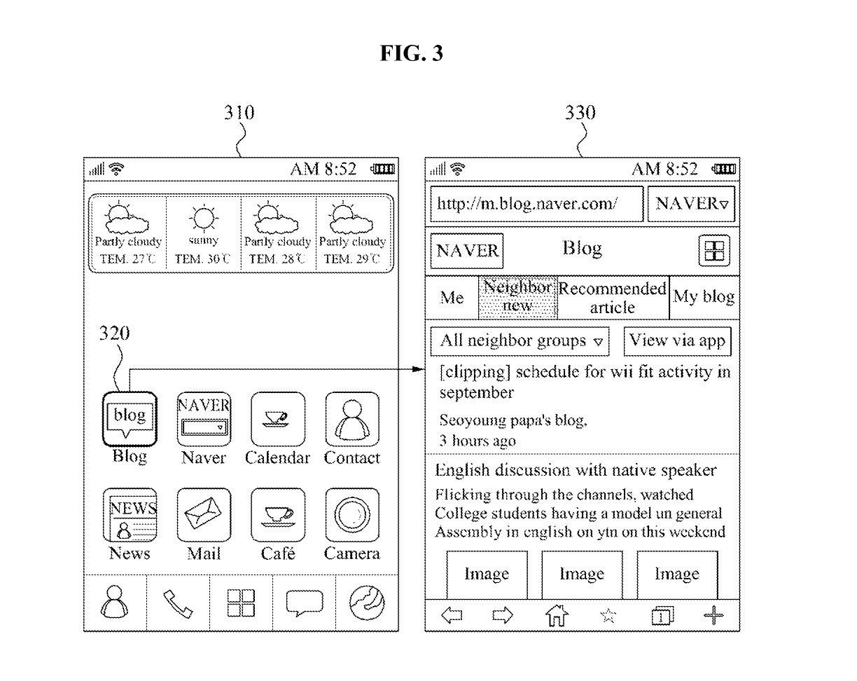

FIG. 3 illustrates activation of a shortcut installed on a desktop according to exemplary embodiments of the present invention. When a shortcut icon to a service is installed on a desktop of a mobile device, a desktop 310 as shown in FIG. 3 may be displayed. The desktop 310 may display a shortcut 320 to the web service used on the browser 210 of FIG. 2, for example, a blog shortcut according to the present exemplary embodiment.

When the shortcut 320 is activated, a main page of the web service may be presented, since a URL scheme to be referred to in the installation of the shortcut may correspond to a URL scheme for the main page of the web service. The shortcut 320 installed via the connecting application may be activated in a connecting application environment 330. The connecting application may include a browser function. In some embodiments, whether the shortcut 320 is to be activated on the browser or in the connecting application environment may be selected when the shortcut 320 is activated.

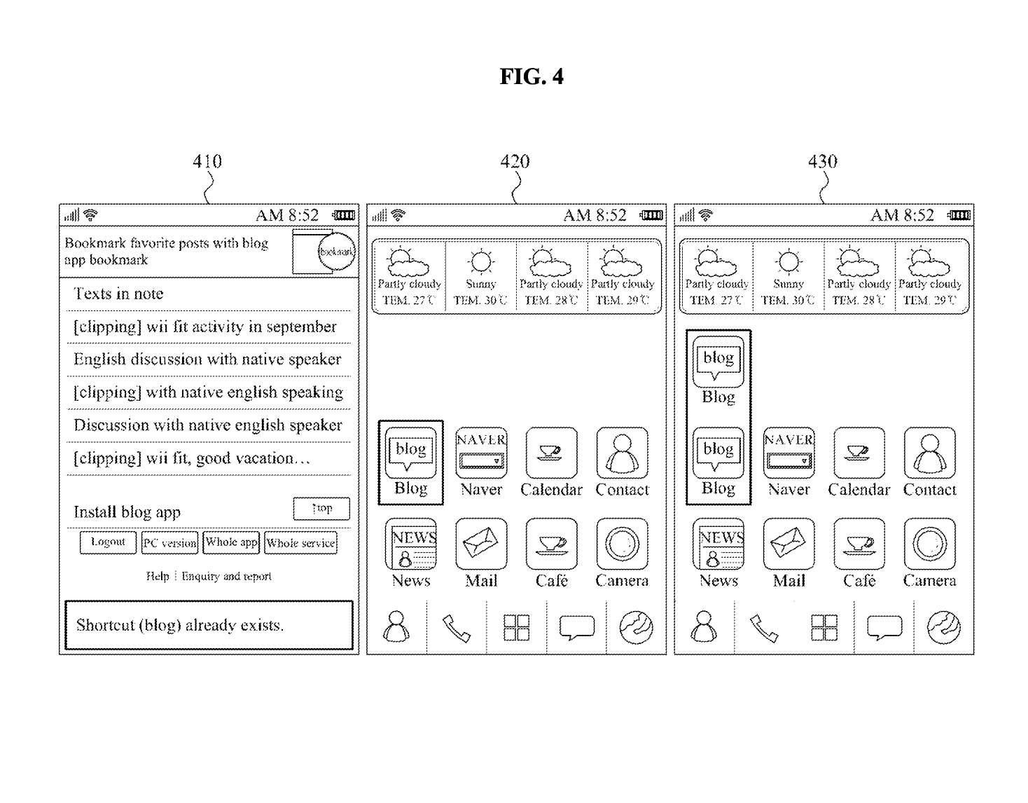

FIG. 4 illustrates a shortcut previously installed according to exemplary embodiments of the present invention. FIG. 4 illustrates a page displayed when the system determines that there is a duplication of a shortcut after the link for installing the shortcut is selected on the web service page in the browser environment of FIG. 2. When the web service is selected in a browser, and when the browser cannot verify whether the shortcut is installed on the desktop, the browser may display the link for installing the shortcut irrespective of the shortcut being installed.

In the present exemplary embodiment, when the shortcut to the web service is installed on the desktop and installation of the shortcut to the web service is activated on the browser, the system may display a popup 410 indicating that the shortcut is installed in the form of a notification to the user, for example, “Shortcut (blog) already exists.”

Here, the popup 410 is a toast type popup, which may be provided by the mobile device. A toast type popup may not allow a user touch to be detected while displaying the notification. The popup 410 may be displayed momentarily and then disappear, and be presented in different modes based on a type of the mobile device or installation of a launcher.

When the browser is shut down after the notification on the popup 410 is provided, a desktop on which the shortcut is not installed after duplication of the shortcut is identified, for example, a desktop 420, may be displayed, or a desktop on which the shortcut is installed irrespective of duplication of the shortcut, for example, a desktop 430, may be displayed. A mobile device using the ANDROID operating system may display the desktop 420 or the desktop 430, which may be determined based on a type of the device and installation of a launcher.

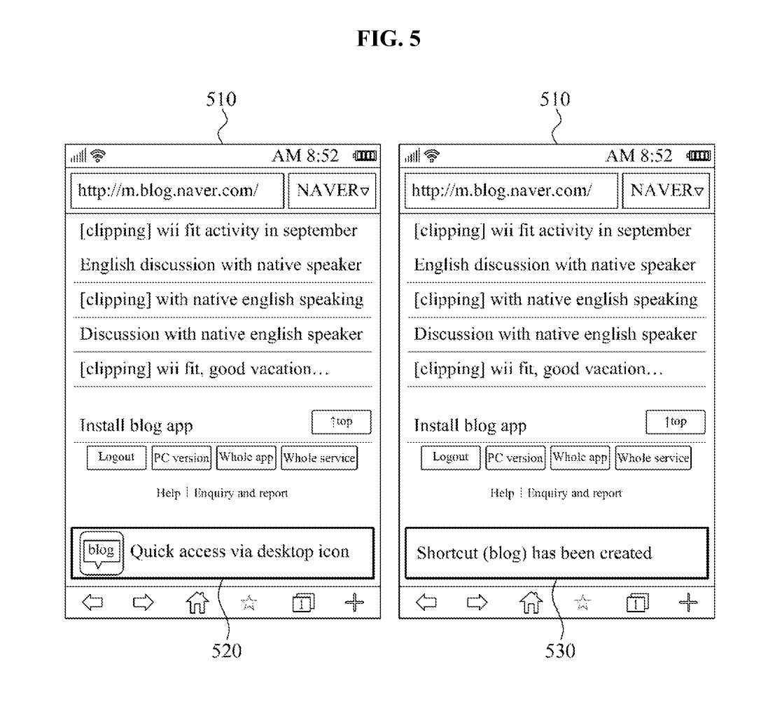

FIG. 5 illustrates creation of a shortcut in a connecting application environment according to exemplary embodiments of the present invention. During an installation of a shortcut in a connecting application environment 510, a web service page is displayed in a manner of the exemplary embodiment of FIG. 2. In FIG. 5, installation of a shortcut being executed in the connecting application environment 510, not in browser 210, is illustrated. A shortcut being installed in an application environment is provided.

A link 520 for installing a shortcut is displayed by the connecting application 510, for example, at a bottom of the web service page. A shortcut is installed on a desktop when the link 520 is selected with a finger or a touch pen, and the mobile device may display a popup 530 indicating that the shortcut is properly installed. Here, the popup 530 is a toast type popup, which may be provided by the mobile device.

In the present exemplary embodiment, a process of separately importing the connecting application, executed in the connecting application environment 510, may be omitted, and a URL scheme may be readily imported from the running application. In this manner, the URL scheme for the web service specified by the connecting application 510 is imported and the shortcut to the displayed web service may be disposed on the desktop based on the URL scheme, rather than by an application installation program.

After installation of the shortcut through the connecting application as shown in FIG. 5, the exemplary embodiment shown in FIG. 3 may be applied. When the connecting application installed on the desktop is activated, a main page of the web service may be displayed since a URL scheme may correspond to a URL scheme for the main page of the web service. Similarly, the shortcut installed via the connecting application may be activated in the connecting application environment.

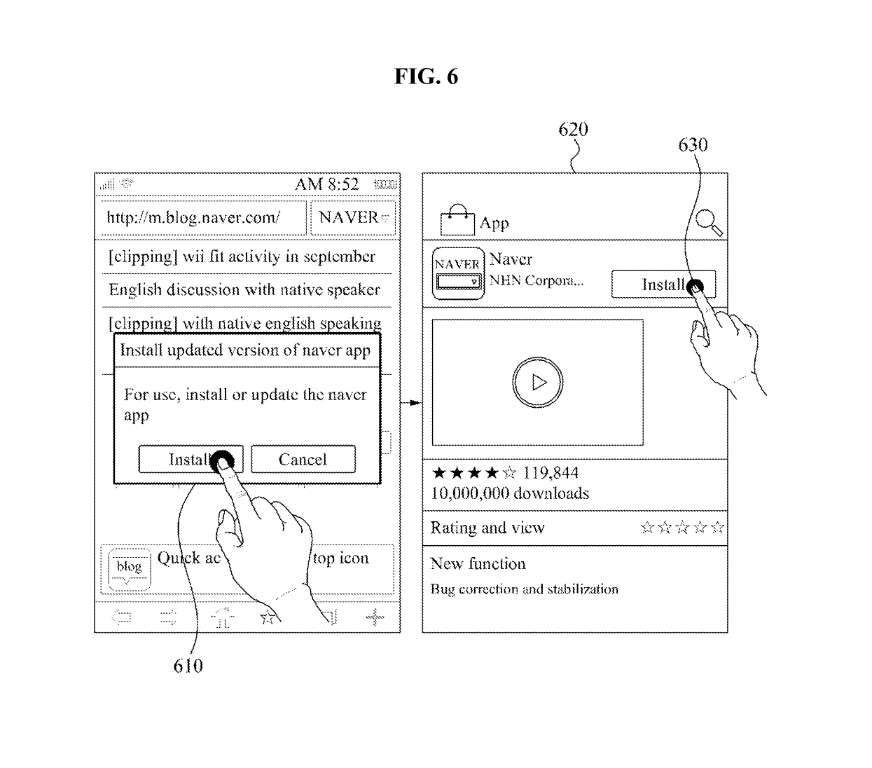

FIG. 6 illustrates a connecting application that is yet to be installed or requires updating to support a URL scheme according to an exemplary embodiment of the present invention. In FIG. 6, an exemplary connecting application “Naver App” is used for illustration.

When a connecting application is not present or a version of the connecting application requiring an update is installed during installation of a shortcut to a web service on a browser, the system displays a pop-up window 610 to indicate that installation or updating of the connecting application is necessary.

In the present exemplary embodiment, when a cancel button on the pop-up window 610 or a back button on the mobile device is pressed, installation of the shortcut may be canceled and the pop-up window 610 closed. When an Internet browser scheme is used in an ANDROID environment, connection to a digital content program 620 conducting automatic updating and installation may be induced in the digital content program 620, for example, a GOOGLE PLAY application. The digital content program 620 may provide an installation page or an update page as necessary.

In the present exemplary embodiment, when an installation button or an update button 630 provided as a link is selected, the connecting application is downloaded and installed via the digital content program. When download and installation of the connecting application is completed, the user may return to the browser displaying a web content and install the shortcut. Accordingly, a corresponding icon may be created on the desktop.

In an operating system where application installation via a shortcut icon to a web service according to the present exemplary embodiment is not supported, for example, Apple's mobile operating system (IOS), an additional process would be necessary. In such an environment, the system may identify the OS as an unreadable URL so that an error popup or web page may be displayed, for example, rather than the install URL.

In some embodiments, when the connecting application stored in the mobile device is deleted, the shortcut icon to the web service installed according to the present exemplary embodiment may also be deleted. In some embodiments, deletion of the connecting application means that the connecting application is completely deleted from the device. The deletion of the connection program may be performed through the digital content program 620. Here, when the shortcut icon is installed with reference to the URL scheme of the connection application, the shortcut icon installed via the digital content program 620 may be also deleted.

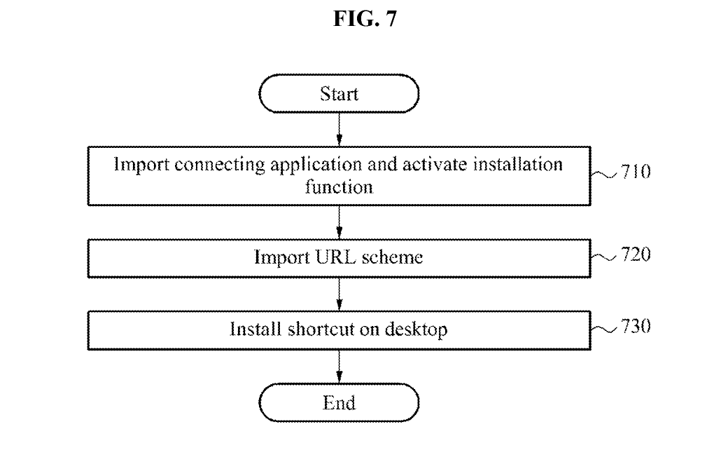

FIG. 7 illustrates a method of installing a shortcut on a desktop according to exemplary embodiments of the present invention. The shortcut installation method according to the exemplary embodiments may be executed via a mobile device including, for example, an ANDROID operation system.

In operation 710, the mobile device may import a connecting application and activate an installation function on a browser providing a web service. For example, the device may import the connecting application by identifying activation of a link associated with installation of a shortcut provided on the browser, and activate the installation function. In the exemplary embodiment, the link may be displayed not only on a main page of the web service, but also on a subpage thereof, and the web service providing a shortcut service may include various types of web services, such as, an e-mail service, a café, a dictionary, a blogging service, a shopping mall, a map, a real estate service, and an online storage service.

In operation 720, the mobile device may import a URL scheme specified by the imported connecting application. When the link is activated on the page providing the web service, a corresponding URL scheme is transmitted to the mobile device system. The system may identify the URL scheme and search for an executable application in accordance with the URL scheme. When an application accommodating the URL is found in the system, the corresponding application is activated and the URL scheme is transmitted to the application, thereby installing the shortcut. Here, the corresponding application may be the connecting application.

In the present exemplary embodiment, the connecting application specifies and stores the URL scheme for the web service, and the URL scheme operating as described above may be used in the present invention.

Here, in operation 710, whether the connecting application is installed or is a version requiring an update may be determined. In this case, the operation of the URL scheme may not be executed properly in operation 720 and thus, connection to a digital content program is enabled through a popup indicating installation or updating of the connection application is necessary.

In operation 730, the shortcut to the web service may be installed on the desktop using the imported URL scheme. Here, the connecting application may perform an application installation function instead of the digital content program, such as, the GOOGLE PLAY application, installing an application.

The shortcut installation method may include a process of activating the shortcut (not shown), in which the mobile device may provide the web service in a connecting application environment when the shortcut is activated. Further, a web page provided in the process of activating the shortcut is the main page of the web service, which may be activated as a URL scheme of the main page of the web service imported in operation 720.

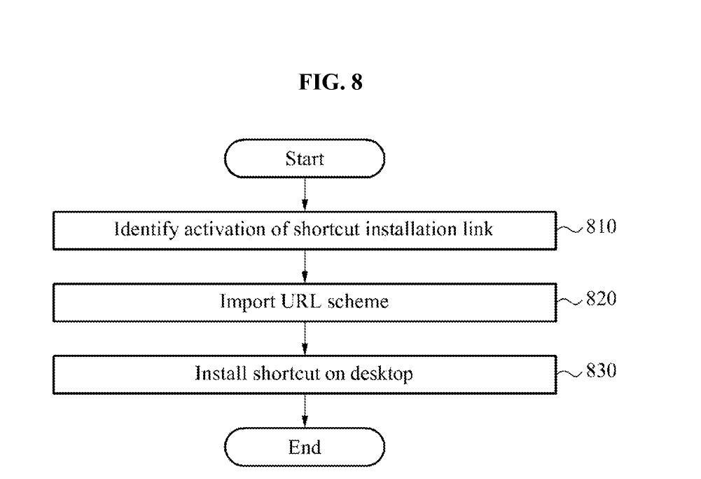

FIG. 8 illustrates a method of installing a shortcut in a connecting application environment according to exemplary embodiments of the present invention. The shortcut installation method according to the present exemplary embodiment may be executed in, for example, an ANDROID environment of a mobile device, such as, a smartphone or a tablet PC. Accordingly, the connecting application may provide a web service including a browser function.

In FIG. 8, operation 810 may be carried out without importing a separate connecting application, in which the mobile device identifies activation of a shortcut installation link on a web service page because the shortcut is installed in the connecting application environment.

When activation of the installation link is identified in operation 810, the mobile device may import a URL scheme specified by the running connecting application in operation 820. Here, the URL scheme specified by the connecting application may correspond to a main page of the web service. A shortcut to the web service, for example, an e-mail service, a café, a dictionary, a blogging service, a shopping mall, a map, a real estate service, or an online storage service, may be installed on a desktop.

In operation 830, the shortcut to the web service may be installed on the desktop based on the URL scheme. The connecting application may perform an application installation function instead of a digital content program, such as, the GOOGLE PLAY application, installing an application. The present exemplary embodiment enables a user of the mobile device to install a shortcut.

The shortcut installation method may include a process of activating the shortcut (not shown), in which the mobile device may provide the web service in the connecting application environment when the shortcut is activated. Further, a web page provided in the process of activating the shortcut is the main page of the web service, which may be activated as a URL scheme of the main page of the web service is imported in operation 820.

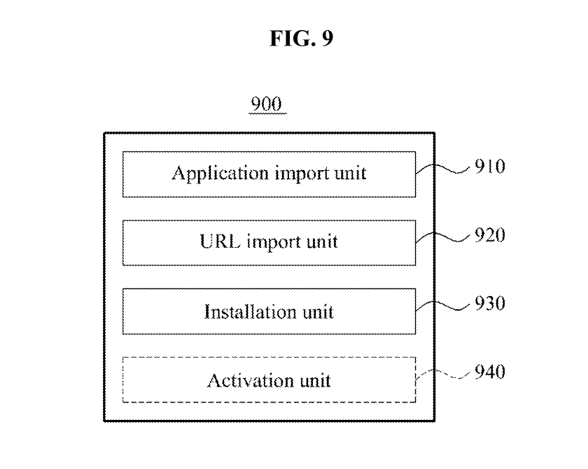

FIG. 9 illustrates a system 900 for installing a shortcut on a desktop according to exemplary embodiments of the present invention. The shortcut installation system 900 may be used for executing the shortcut installation method of FIG. 7. The system 900 can be included in a mobile device to install a shortcut on a desktop of the mobile device.

According to the exemplary embodiment shown in FIG. 9, the shortcut installation system 900 may be configured to include an application import unit 910, a URL import unit 920, and an installation unit 930, and further include an activation unit 940 depending on exemplary embodiment.

When the application import unit 910 identifies activation of a link or an icon for installing a shortcut, and then imports a connecting application and activates an installation function, the URL import unit 920 may import a URL scheme specified by the connecting application. The URL scheme may include a protocol about a web service. The installation unit 930 may install a shortcut to the web service on the desktop with reference to the imported URL scheme. The system 900 can include an activation unit 940, which enables the web service to be provided in a connecting application environment when the shortcut is activated on the mobile device.

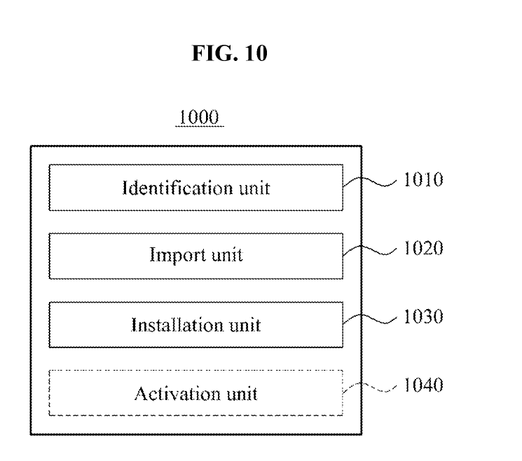

FIG. 10 illustrates a system 1000 for installing a shortcut on a desktop according to exemplary embodiments of the present invention. The shortcut installation system 1000 may be used for executing the shortcut installation method of FIG. 8. The system 1000 can be included in a mobile device to install a shortcut on a desktop of the mobile device. According to the exemplary embodiments shown in FIG. 10, the shortcut installation system 1000 may be configured to include an identification unit 1010, an import unit 1020, an installation unit 1030, and an activation unit 1040.

When the identification unit 1010 identifies activation of a link for installing a shortcut in a connecting application environment, the import unit 1020 may import a URL scheme for a service from a running connecting application, the installation unit 1030 may install a shortcut on a desktop with reference to the URL scheme, and the activation unit 1040 enables the web service to be provided in the connecting application environment when the shortcut is activated. Here, the connecting application may include a browser function.

Since installation of a shortcut on a desktop of a mobile device is described in detail with reference to FIGS. 1 to 6, repeated descriptions are omitted in FIGS. 7 to 10 for ease of description and conciseness.

As described above, exemplary embodiments of the present invention may provide a method of conveniently installing a shortcut on a desktop, when compared to a conventional method, in order for a user to use a frequently used web service and a system for carrying out the method.

In addition, exemplary embodiments of the present invention may provide a method and a system for installing shortcuts to various web services provided through a connecting application on a mobile device, thus enabling a user to use the web services conveniently.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more non-transitory computer readable recording mediums.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM discs and DVD; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A computer-implemented method of installing a shortcut on a desktop, the method comprising:
importing, by the computer, a connecting application and activating an installation function on a browser configured to provide a web service;
importing a uniform resource locator (URL) scheme specified by the connecting application; and
installing a shortcut to the web service on the desktop.

2. The method of claim 1, wherein the method of installing the shortcut comprises activating a link or an icon for installing a shortcut on the browser and the computer deploys an ANDROID environment.

3. The method of claim 1, wherein the connecting application comprises a browser function capable of providing the web service, and the web service comprises at least one of an e-mail service, a café, a dictionary, a blogging service, a shopping mall, a map, a real estate service, and an online storage service.

4. The method of claim 1, wherein the method comprises activating the shortcut to provide the web service on the connecting application.

5. The method of claim 4, wherein the importing of the URL scheme imports a URL scheme of a main page of the web service specified by the connecting application, and the activating of the shortcut provides the main page of the web service.

6. The method of claim 1, wherein the importing of the connecting application and the activating of the installation function comprises identifying whether the connecting application is installed on the mobile device or identifying whether a version of the connecting application requires an update, providing a popup to connect to a digital content program, and installing or updating the connecting application through the digital content program.

7. A computer-implemented method of installing a shortcut on a desktop, the method comprising:
identifying, by the computer, activation of a link for installing a shortcut associated with a connecting application providing a web service;
importing a uniform resource locator (URL) scheme specified by the connecting application; and
installing a shortcut for activating the web service on the desktop.

8. The method of claim 7, wherein the connecting application comprises a browser function capable of providing the web service, and the web service comprises at least one of an e-mail service, a café, a dictionary, a blogging service, a shopping mall, a map, a real estate service, and an online storage service.

9. The method of claim 7, wherein the method of installing the shortcut comprises activating the shortcut, and the activating of the shortcut provides the web service on the connecting application.

10. A system for installing a shortcut on a desktop, the system comprising:
an application import unit configured to import a connecting application and activate an installation function on a browser providing a web service;
a uniform resource locator (URL) import unit configured to import a URL scheme specified by the connecting application;
an installation unit configured to install a shortcut to the web service on the desktop; and
a processor to execute one or more of the application import unit, the URL import unit, and the installation unit.

11. The system of claim 10, wherein the installation unit is further configured to activate a link or an icon for installing a shortcut on the browser, and the computer deploys an ANDROID environment.

12. The system of claim 10, wherein the connecting application comprises a browser function capable of providing the web service, and the web service comprises at least one of an e-mail service, a café, a dictionary, a blogging service, a shopping mall, a map, a real estate service, and an online storage service.

13. The system of claim 10, further comprises an activation unit configured to activate the shortcut, and the activation unit provides the web service associated with the connecting application.

14. The system of claim 13, wherein the URL import unit imports a URL scheme of a main page of the web service specified by the connecting application, and the activation unit provides the main page of the web service.

15. The system of claim 10, wherein the application import unit is configured to identify whether the connecting application is installed on the mobile device, configured to identify whether a version of the connecting application requires an update, configured to provide a popup to connect to a digital content program, and configured to install or update the connecting application through the digital content program.
